(19) United States
(12) Patent Application Publication
(10) Pub. No.: US 2008/0015981 A1
(43) Pub. Date: Jan. 17, 2008

(54) Process for supplying fuel

(76) Inventor: Andre Danesh, Brookline, MA (US)

Correspondence Address: Robert G. Rosenthal, Suite 200, 5856 Faringdon Place, Raleigh, NC, 27609, US

(21) Appl. No.: 11/820,258

(22) Filed: Jun. 19, 2007

Related U.S. Application Data
(60) Provisional application No. 60/819,967, filed on Jul. 11, 2006.

(51) Int. Cl. G06Q 40/00; G06Q 50/00

(52) U.S. Cl. 705/39

(57) ABSTRACT

A fuel supplier, having one or more retail outlets, sells a fuel futures contract to a consumer at a price per unit volume for the fuel set at the time of creating the futures contract. The fuel futures contact is pre-paid by the consumer thereby creating a credit balance with the supplier against future purchases of fuel. The credit is taken by the consumer at any desired time, optionally within a defined term, by the purchase of fuel at a price per unit volume of fuel preset at the time of purchase of the futures contact. Each purchase of fuel results in a commensurate decrease in the consumer's credit balance with the supplier.

### PRIOR APPLICATION

This application claims priority from U.S. Provisional Patent Application Ser. No. 60/819,967 filed Jul. 11, 2006.

### FIELD OF THE INVENTION

This invention relates to a process for supplying fuel, such as gasoline, to a consumer. More specifically, this invention relates to a means to protect both a fuel supplier and its consumers from significant price inflation or price fluctuation.

### BACKGROUND OF THE INVENTION

It is known that the price of gasoline fluctuates significantly based upon a number of factors such as the availability of crude oil, refining capacity, weather and geo-political events. Over the long term, many believe the price of fuel will increase from its current historically high price. These price fluctuations make it difficult for the supplier to engage in budget forecasting and business planning. The consumer, such as an individual or business, faces difficulties as price increases adversely impact the home or business budget.

It is therefore an object of the present invention to improve the sale and distribution of fuel over the prior art.

Another object of the present invention is to improve efficiency, for both the supplier and the consumer, in the distribution and/or sale of fuel products.

Still another object of the present invention is to enable the consumer to lock in the price of fuel to be used in the future, through the purchase of a futures contract.

Yet another object of the present invention is to enable the sale and purchase of fuel through the use of electronic commerce means, such as the use of a credit or debit card.

These and other objects and advantages will become evident upon review of the embodiment disclosed. It is noted that not all embodiments disclosed, taught or claimed herein necessarily meet each one of the objectives noted above, but that in no way should be construed to place the embodiment within or outside of the bounds of the inventions presented herein.

### SUMMARY OF THE INVENTION

In one embodiment consistent with the present invention, a process for supplying fuel is disclosed. According to the process, a fuel supplier, having one or more retail outlets, sells a fuel futures contract to a consumer at a price per unit volume for the fuel set at the time of creating the futures contract. The fuel futures contact is pre-paid by the consumer thereby creating a credit balance with the supplier against future purchases of fuel. The credit is taken by the consumer at any desired time, optionally within a defined term, by the purchase of fuel at a price per unit volume of fuel preset at the time of purchase of the futures contact. Each purchase of fuel results in a commensurate decrease in the consumer's credit balance with the supplier.

### DETAILED DESCRIPTION OF THE PREFERRED EMBODIMENT

While this invention is susceptible of embodiment in many different forms and will herein be described in detail specific a embodiment(s), with the understanding that the present disclosure of such embodiments is to be considered as an example of the principles and not intended to limit the invention to the specific embodiments shown and described.

The process of the subject invention involves the sale of fuel futures, especially, gasoline futures. In accordance with the invention, a supplier would sell it's consumers a pre-paid bulk allocation of fuel at its then prevailing price per unit of fuel, thus, the purchaser would lock in a preselected dollar amount representing a certain volume of fuel, or visa versa. The consumer would make a one time payment to the supplier at the time of purchase and would receive a credit towards future purchases at the supplier's outlets. For each future purchase of a volume of fuel by the consumer, the consumer's existing credit volume balance would be reduced commensurately by and amount equal to the volume purchased, thus insulating the consumer from price fluctuations, the fuel having been pre-paid. The credit against future purchases could continue indefinitely until fully used or could have a time limit, in accordance with the terms of the futures contract as set by the supplier.

The following is an example of how the supply process of the invention might operate using gasoline as an example. A consumer would pay a supplier of gasoline a single payment of, for example, one thousand dollars. This payment then represents a certain number of gallons of gasoline purchased on that date at the then prevailing price. The supplier would create a credit account for the consumer and issue a credit instrument to the consumer, preferably in the form of a credit or debit card, for the purchase of the volume of gasoline at the supplier's outlets. The card would have encoding that would identify the consumer and the supply arrangement such that when the card was used, the correct charge to the consumer and a debit from the consumer's existing credit balance would be made. Consequently, each purchase of gasoline by the consumer would result in a decrease in the consumer's credit balance by the amount of the purchase. For the purposes of this example, the period of time during which the credit would continue would not be limited, but could be of any duration such as three years from or for a term as set by the supplier.

The supply process of the invention is beneficial both to the supplier and the consumer. The supplier receives pre-payment thereby benefiting from the use of the payment for business purposes and is better able to project its future inventory requirements of the fuel. The consumer is protected against future price increases.

While certain illustrative embodiments have been described, it is evident that many alternatives, modifications, permutations and variations will become apparent to those skilled in the art in light of the foregoing description

That which is claimed is:

1. A process for supplying fuel, said process comprising:
a fuel supplier, having one or more retail outlets,
selling a fuel futures contract to a consumer at a price per unit volume for the fuel set at the time of creating the futures contract, the fuel futures contact being pre-paid by the consumer thereby creating a credit balance with the supplier against future purchases of fuel, the credit being taken by the consumer at any desired time, optionally within a defined term, by the purchase of fuel at a price per unit volume of fuel preset at the time of purchase of the futures contact, each purchase of fuel resulting in a commensurate decrease in the consumer's credit balance with the supplier.

2. The process according to claim 1 wherein the wherein the fuel is gasoline.

3. The process according to claim 1 wherein the futures contract is purchased electronically.

4. The process according to claim 1 wherein the credit balance may be used at any one of the supplier's retail outlets.
